(19) United States
(12) Patent Application Publication
(10) Pub. No.: US 2026/0129477 A1
(43) Pub. Date: May 7, 2026

(54) FUNCTIONALITY MANAGEMENT IN WIRELESS NETWORKS BASED ON UE AND NETWORK SIDE INFORMATION

(71) Applicant: SHARP KABUSHIKI KAISHA, Sakai City (JP)

(72) Inventors: Rudraksh Shrivastava, Erligheim (DE); Sudeep Hegde, Stuttgart (DE); Tomoki Yoshimura, Camas, WA (US)

(21) Appl. No.: 18/940,725

(22) Filed: Nov. 7, 2024

(51) Int. Cl. H04W 24/02; H04W 8/22; H04W 76/20

(52) U.S. Cl. CPC H04W 24/02; H04W 8/22; H04W 76/20

(57) ABSTRACT

A UE determines a UE side associated ID for each of the UE that corresponds to a network side associated ID. The UE side associated ID is determined based on a first set of aspects of the UE. The UE determines, based on a second set of aspects of the UE, a stability index for each functionality of the UE that corresponds to the network side associated ID. The UE determines the applicability of a particular functionality of the UE based on the network side associated ID and a UE side associated ID determined for the particular functionality. The UE determines, based on a stability index determined for the particular functionality and its associated network side associated ID, a duration of time before activating the particular functionality when the particular functionality is not activated, and a duration of time before deactivating the particular functionality when the particular functionality is activated.

### TECHNICAL FIELD

The technology generally relates to wireless communications, and more particularly, to exchanging user equipment (UE) side identifications and stability index between UEs and the network.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the integration of artificial intelligence/machine learning (AI/ML) continues to expand in the 5G NR networks, it has become crucial for UE to accurately discern its serving and neighboring cells' AI/ML functionalities, for example, to ensure smooth handoffs, timely activation of relevant features, and efficient allocation of network resources. However, challenges emerge from dynamic network conditions, as the availability and capabilities of neighboring cells may vary due to factors such as traffic load and interference. In addition, the UE's own capabilities, internal conditions, model availability, and the inherent complexity of 5G NR networks (e.g., including integrated access and backhaul (IAB) systems) further complicate this assessment. To accurately determine the applicable functionalities of neighboring base stations (e.g., next-generation Node Bs (gNBs)) and cells, the UE has to be provided with relevant network-side information, including the appropriate timing for assessing neighboring cell functionalities and the methods for reporting this information back to the network. Reporting neighboring cell AI/ML functionality information may introduce signaling overhead that may affect network performance.

As the demand for radio access continues to grow, however, there is a need for further improvements in wireless communications in the next-generation radio communication systems, such as improvements in the network mobility management.

### SUMMARY

In a first aspect of the present application, a UE is provided. The UE includes one or more non-transitory computer-readable media storing one or more computer-executable instructions and at least one processor coupled to the one or more non-transitory computer-readable media. The at least one processor is configured to execute the one or more computer-executable instructions to cause the UE to receive, from a network node, a network side associated identifier (ID) quantifying one or more network side conditions; determine a UE side associated ID for each functionality in a set of one or more functionalities of the UE that corresponds to the network side associated ID, the UE side associated ID determined based on a first set of aspects of the UE; determine a stability index for each functionality of the UE that corresponds to the network side associated ID, the stability index calculated based on a second set of aspects of the UE; determine an applicability of a particular functionality of the UE based on the network side associated ID and a UE side associated ID determined for the particular functionality; and determine, based on a stability index determined for the particular functionality and its associated network side associated ID, a duration of time before activating the particular functionality when the particular functionality is not activated, and a duration of time before deactivating the particular functionality when the particular functionality is activated.

In an implementation of the first aspect, the network side associated ID is a first network side associated ID. The at least one processor is further configured to execute the one or more computer-executable instructions to cause the UE to receive, from the network node, a set of one or more network side associated IDs other than the first network side associated ID. Each network side associated ID in the set of one or more network side associated IDs quantifies one or more network side conditions. Determining the applicability of the particular functionality of the UE further includes determining the applicability of the particular functionality of the UE based on the set of one or more network side associated IDs.

In another implementation of the first aspect, each stability index specifies a probability that the corresponding functionality of the UE remains applicable for a time interval after the functionality of the UE is activated or a probability that the functionality of the UE remains applicable for a time interval prior to the functionality of the UE being activated.

In another implementation of the first aspect, each functionality of the UE provides a set of inference results, and the stability index further quantifies a UE's confidence level in the accuracy or reliability of the set of inference results.

In another implementation of the first aspect, each functionality of the UE is one of an AI/ML functionality that the UE is ready to apply for AI/ML model inference or an AI/ML functionality that the UE supports based on UE capabilities.

In another implementation of the first aspect, the first set of aspects of the UE includes at least one of a UE hardware resource from several UE hardware resources that are required for performing the corresponding functionality of the UE, the mobility of the UE, or the type of the environment where the UE is located.

In another implementation of the first aspect, the UE hardware resources includes one or more of the UE power consumption, the memory storage of the UE, the operating frequency of a graphics processing unit (GPU) of the UE, and the operating frequency of the at least one processor.

In another implementation of the first aspect, the second set of aspects of the UE includes at least one of a UE hardware resource from several UE hardware resources required for performing the corresponding functionality of the UE, the mobility of the UE, or the type of the environment where the UE is located.

In another implementation of the first aspect, determining the UE side associated ID includes determining the UE side associated ID as a function of a score for the battery level of the UE, a score for the availability of computational resources of the UE, a score for environmental conditions and mobility of the UE, and a score on the past effectiveness of the corresponding functionality; and determining the UE side associated ID by mapping a value generated by the function into one of several values in a predetermined range of values.

In another implementation of the first aspect, the function is non-weighted average or a weighted average.

In another implementation of the first aspect, determining the stability index includes calculating a function of the probability of the occurrence of each aspect in the second set of aspects of the UE.

In another implementation of the first aspect, determining the stability index includes calculating several probabilities for different moving speeds of the UE in different environments; summing the probabilities; and calculating a normalized probability by dividing the sum of probabilities by the number of probabilities.

In another implementation of the first aspect, determining the stability index corresponding to a functionality of the UE includes calculating a probability that the battery level of the UE is above a threshold; and calculating a probability that computational resources required for performing the functionality of the UE is below a threshold.

In another implementation of the first aspect, the at least one processor is further configured to execute the one or more computer-executable instructions to cause the UE to maintain a mapping of an identification of the UE, the UE side associated ID, the network side associated ID representing the one or more network side conditions, the functionalities of the UE, an applicability status of each functionality of the UE, an activation status of each functionality of the UE, and the stability index.

In a second aspect of the present application, a method is provided. The method includes receiving, by a UE, from a network node, a network side associated ID quantifying one or more network side conditions; determining a UE side associated ID for each functionality in a set of one or more functionalities of the UE that corresponds to the network side associated ID, the UE side associated ID determined based on a set of aspects of the UE; determining a stability index for each functionality of the UE that corresponds to the network side associated ID, the stability index calculated based on a set of aspects of the UE; determining an applicability of a particular functionality of the UE based on the network side associated ID and a UE side associated ID determined for the particular functionality; and determining, based on a stability index determined for the particular functionality and its associated network side associated ID, a duration of time before activating the particular functionality when the particular functionality is not activated, and a duration of time before deactivating the particular functionality when the particular functionality is activated.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIG. 2 is a sequence diagram illustrating an example message flow of a signaling framework for applicable functionality reporting for a beam management UE side model, according to an example implementation of the present disclosure.

FIG. 3 illustrates a table that shows an example mapping of each UE to the corresponding UE side associated IDs and the corresponding network side associated ID, according to an example implementation of the present disclosure.

FIG. 4 illustrates a table that shows an example mapping of each UE to a corresponding set of parameters, according to an example implementation of the present disclosure.

FIG. 5 is a flowchart illustrating an example method/process performed by a UE for determining one or more UE side associated IDs and one or more stability indexes, according to an example implementation of the present disclosure.

FIG. 6 is a sequence diagram illustrating an example message flow of a signaling framework in which the UE decides the applicable functionalities, according to an example implementation of the present disclosure.

FIG. 7 is a sequence diagram illustrating an example message flow of a signaling framework in which the network decides the applicable functionalities, according to an example implementation of the present disclosure.

FIG. 8 is a sequence diagram illustrating an example message flow of a signaling framework in which the UE and the network jointly decide the applicable functionalities, according to an example implementation of the present disclosure.

FIG. 9 is a flowchart illustrating an example method/process performed by a UE where the UE determines one or more applicable functionalities and sends the applicable functionalities to the network node, according to an example implementation of the present disclosure.

FIG. 10 is a flowchart illustrating an example method/process performed by a network node where the network node determines one or more applicable functionalities of the UE, according to an example implementation of the present disclosure. and

FIG. 11 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel typically includes several antenna elements. A beam can be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-)configuration. If the firstActiveUplinkBWP IE field is absent, the RRC (re-)configuration may not impose a BWP switch. If the first active uplink BWP is configured for an SCell, the firstActiveUplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:

‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.

Panel: The UE panel information may be derived from the TCI state/UL beam indication information or from the network signaling.

Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).

TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.

TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.

TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.

Frequency Division Multiplexing (FDM) based PDSCH repetition: Multiple PDSCHs with the same TB but corresponding to two TCI states. These PDSCHs are allocated to non-overlapping frequency resources within a slot.

Multi-DCI based PDSCH scheme: Two PDCCHs from separate search spaces associated with different CORESET pool indexes that schedule the corresponding PDSCHs.

Single Frequency Network (SFN) based PDCCH scheme: A CORESET is associated with two different beams.

SFN based PDSCH scheme: A PDSCH is associated with two different beams.

Measurement objects: A list of objects on which the UE shall perform the measurements. For intra-frequency and inter-frequency measurements, a measurement object indicates the frequency/time location and subcarrier spacing of the reference signals to be measured. Associated with this measurement object, the network may configure a list of cell specific offsets, a list of exclude-listed cells and a list of allow-listed cells. The exclude-listed cells are not applicable in event evaluation or measurement reporting. The allow-listed cells are the only cells that are applicable in event evaluation or measurement reporting.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication”. The “DL only” and “UL only” may also be referred to as a “separate TCI state,” as opposed to the “joint TCI state”.

Unified TCI states may be indicated through an RRC message, a Medium Access Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:
Single DCI based TDM PDSCH repetition;
Single DCI based FDM PDSCH repetition;
Multi-DCI based PDSCH;
TDM PDCCH repetition;
FDM PDCCH repetition;
Single DCI based TDM PUSCH repetition;
TDM PUCCH repetition;
SFN based PDCCH scheme;
SFN based PDSCH scheme;
Single DCI based FDM PUSCH repetition;
Multi-DCI based PUSCH;
FDM PUCCH repetition;
SFN based PUSCH scheme; and
SFN based PUCCH scheme.

When the unified TCI framework is applied to at least one multi-TRP scheme, some changes may be needed. The changes may include the association between the unified indication and at least one TRP, the mapping order of the indicated TCI states, the association between the unified indication and the respective channel, and/or the method of signaling for each channel. In the present disclosure, implementations for applying the unified TCI framework to the multi-TRP scheme are disclosed hereinafter.

The 3GPP (e.g., as indicated in Release 18, study item (SI) on artificial intelligence/machine learning (AI/ML) for air interface) has identified the following scopes: (i) identify use cases and scenarios where the AI/ML may be effectively applied within the 3GPP-defined network architectures and protocols, (ii) study the integration of the AI/ML algorithms into the network functions, protocols, and management systems to enable intelligent decision-making and automation, and (iii) evaluate the impact of the AI/ML on the network scalability, reliability, energy efficiency, spectral efficiency, and quality of service.

For an AI/ML based beam management (BM) use case, the following two use cases may be selected, as the representative AI/ML sub-use cases. The first use case (BM-Case1) may include spatial-domain downlink beam prediction for a first set of beams (e.g., Set A of beams) based on measurement results of a second set of beams (e.g., Set B of beams).

For the BM-Case1, the following alternatives may be considered. The AI/ML model training and inference may be done either at the network side or at the UE side. Set A and Set B may be different (e.g., Set B may not be a subset of Set A) or Set B may be a subset of Set A. It should be noted that Set A is for DL beam prediction. The codebook construction of Set A and Set B may be later defined.

The AI/ML model input may consider the following alternatives: (1) The layer 1 reference signal reception power (L1-RSRP) measurement based on Set B, the L1-RSRP measurement based on Set B and assistance information, the channel impulse response (CIR) based on Set B, or the L1-RSRP measurement based on Set B and the corresponding DL Tx and/or Rx beam ID.

The second use case (BM-Case2) may include temporal downlink beam prediction for Set A of beams based on the historic measurement results of Set B of beams. For the BM-Case2, the following alternatives may be considered. The AI/ML model training and inference may be done either at the network side or at the UE side. Set A and Set B of beams may be different (e.g., Set B may not be a subset of Set A), Set B may be a subset of Set A (e.g., Set A and Set B may not be the same), or Set A and Set B are the same.

The AI/ML model input may consider measurement results of K (K≥1) latest measurement instances with the following alternatives: (1) Only the L1-RSRP measurements based on Set B, (2) The L1-RSRP measurements based on Set B and assistance information, or (3) The L1-RSRP measurements based on Set B and the corresponding DL Tx and/or Rx beam identification (ID). F predictions for F future time instances may be obtained based on the output of the AI/ML model, where each prediction is for each time instance. F may, at least be equal to 1.

Based on the parameters like report of the predicted top-K beam IDs, report of the predicted and/or actual/measured L1-RSRPs associated with the predicted top-K beams, report of the quantities indicating the confidence level of predictions for the top-K beams (e.g., the standard deviation of the predicted L1-RSRPs or statistics of the past RSRP measurements as a proxy for the confidence level of the predictions) and other related parameters like key performance indicators (KPIs), the AI/ML model may provide output in the form of F (f1,f2 . . . fn) predictions for T (t1,t2, . . . tn) future time instances. The prediction may reflect predicted beams and their corresponding configurations.

RAN work group 2 (RAN WG2 or RAN2), during phase 1 discussions, has defined different functionality types for AI/ML functionalities. A functionality may refer to an AI/ML-enabled feature, or feature group, facilitated by a configuration. A functionality, in the context of AI/ML-enabled 5G NR and beyond communication systems, may refer to a specific feature, or a collection of related features, that is enabled by artificial intelligence or machine learning capabilities. These functionalities are supported and managed through configurations, which are sets of parameters or instructions that dictate how the AI/ML enabled 5G NR or beyond system should operate. Essentially, a configuration ensures that the functionality works correctly by providing the necessary settings and data for the AI/ML processes including the life cycle Management (LCM) of the AI/ML model/functionality to work effectively.

During the phase 1 discussion, the following definitions of functionalities have been summarized: (i) supported functionalities refer to functionalities that the user equipment (UE) can indicate by using UE capability signaling, (ii) applicable functionalities refer to functionalities that the UE is ready to apply for model inference, and (iii) activated functionalities refer to functionalities already activated and performing inference.

In phase 2 of the discussions, RAN2 has mainly focused on the signaling framework for the applicable functionality reporting. The applicable functionality is influenced by the NW and UE side additional conditions, which are dynamic in nature and may frequently change. As per the discussions in RAN2, most participants have the following opinion on the NW and UE side additional conditions. In both the network side model and the UE side model, the UE side additional condition may include the UE speed, scenario (e.g., urban, rural, macro, indoor, mobility, etc.), hardware capabilities, etc.

RAN2 has agreed on the following terminologies: (1) supported functionalities refer to functionalities that the UE may indicate by using the UE capability information (e.g., via RRC/LPP signaling), (2) applicable functionalities refer to functionalities that the UE is ready to apply for inference, and (3) activated functionalities refer to functionalities already enabled for performing inference.

RAN work group 1 (RAN WG1 or RAN10 has summarized the network side additional conditions and the associated identifications (IDs) in the document R1-2405680 as follows: (i) mapping relationship of Set A and Set B, including ordering to a set of identifications (IDs), or resources, (ii) consistency of downlink spatial domain transmission filters corresponding to the beams in Set A and Set B, (iii) QCL assumption, (iv) the order of model input and model output between the Rx and Tx beams, which can be pre-defined, (v) transmission power, (vi) UE distribution, (vii) antenna height, (viii) deployment scenarios (e.g., inter-site distance (ISD), urban microcell/urban macrocell (Umi/Uma)), and (ix) ensuring consistency across different cells.

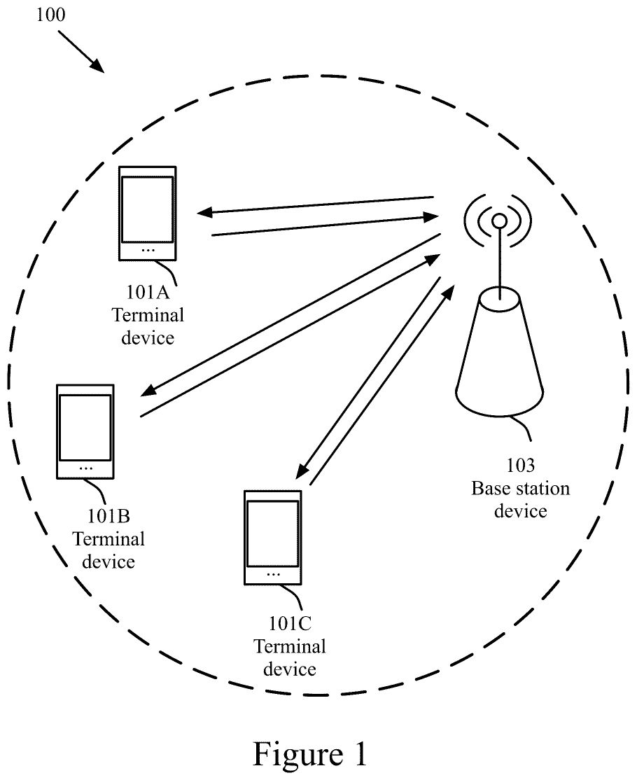

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

BS 103 may include one or more transmission/reception devices. When BS 103 is configured with multiple transmission/reception devices, each of the multiple transmission/reception devices may be arranged at a different position. A transmission/reception device may include a transmission device and/or a reception device.

BS 103 may serve radio communication and provide one or more cells. A cell is defined in this disclosure, as a set of resources used for a wireless communication. A cell may include one or both of a downlink component carrier and an uplink component carrier. A serving cell may include a downlink component carrier and two or more uplink component carriers.

The BS 103, or another network entity, such as a location management function (LMF) server, in some embodiments, may provide multiple sets of configurations to the UE 101A-101C for a given AI/ML functionality. The BS 103, or the other network node, may provide a mechanism to change the configuration sets based on changes in the UE's environment and/or additional conditions.

In a wireless communication system, the RRC configuration process may be used for setting up, maintaining, and modifying the radio connection between the UE and the BS (e.g., a gNB) in the 5G/5G-Advanced (5G-A) networks. The BS 103 or the network entity, may send an RRC message to a UE 101A-101C to configure at least one of the configuration parameters or features of a configuration set. This RRC message may be, for example, RRCSetup, RRCReconfiguration, RRCResume, RRCRelease, or other downlink messages generated by the BS 103 or another network entity. The BS 103 and/or the other network entities are considered as components of the network. In the following discussions, the term network, or network node, refers to any network entity, such as, BS (e.g., gNB), LMF server, etc., and the BS 103 may be used as an example of such network node.

The term “configuration,” herein, may refer to the arrangement and specification of components, settings, or parameters within a system or device, as defined by the applicable agreements, standards, or specifications. The term configuration may encompass the established setup and customization of elements necessary to ensure compliance with contractual obligations, operational requirements, and performance criteria.

### Activating and Deactivating Beam Management Functionalities

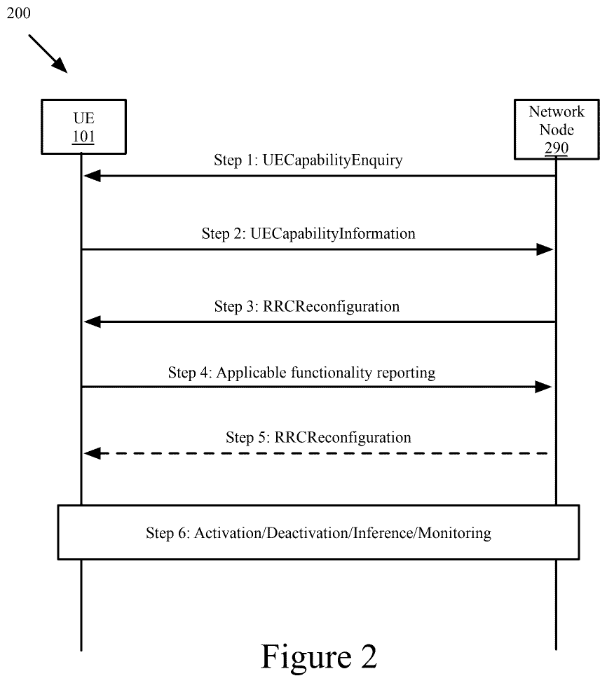

FIG. 2 is a sequence diagram 200 illustrating an example message flow of a signaling framework for applicable functionality reporting for a beam management UE side model, according to an example implementation of the present disclosure. The wireless communications system may be, for example, a 3GPP network, such as, the 5G/5G-A or the 6^{th} generation (6G) NR system. The UE 101 may be any of the UEs 101A-101C and the network node 290 may be the BS 103 shown in FIG. 1 or any other network entity, for example, an LMF server.

The following steps shown in FIG. 2 were agreed in RAN2 meeting #127. In Step 1, the network node 290 may send the UECapabilityEnqiry message to initiate the procedure to the UE 101 reporting the UE's artificial intelligence/machine learning (AI/ML) supported functionalities. In Step 2, the UE 101 may send, to the network node 290, the UECapablityInformation message that may include the supported functionalities at the UE side.

In Step 3, the following configurations may be provided from the network node 290 to the UE 102: (1) the UE 101 may be allowed to do UE Assistance Information (UAI) reporting via OtherConfig and (2) the network node 290 may provide the NW-side additional condition. The RRC signaling and whether it is mandatory or optional is for further study. The configuration (e.g., inference configuration) of supported functionalities and the content of the configuration is for further study.

The UE 101 may decide the applicable functionalities based on the network side additional conditions (if provided by the network node 290), the UE side additional conditions (which are internally known by the UE) and the AI/ML model availability in the device. Whether other configuration may be considered by the UE (e.g., inference configuration) is for further study. How the applicable functionality is decided if the NW-side additional condition is not provided in step 3 and is for further study.

In Step 4, the UE 101 may report the applicable functionality in the following scenarios: (1) upon being configured to provide the applicable functionality and upon change of the applicable functionality via a UAI message and (2) as a response to the NW-side additional condition requesting applicable functionality reporting in Step 3. Other network configuration (e.g., inference configuration) is for further study. Reporting via UAI or RRCReconfigurationComplete, etc., is for further study.

In Step 5: (1) the network node 290 may configure inference configuration to the UE 101 after the applicable functionality reporting, if inference configuration based on supported functionality is not provided in Step 3 (e.g., the inference configuration is provided in Step 5) and (2) if inference configuration based on the supported functionality is provided in Step 3, it is up to the network implementation whether to provide an updated configuration or not.

In Step 6, the applicable functionality may be activated by receiving its inference configuration when it is provided in Step 5. The initial activation state is for further study. The initial state of applicable functionality, if inference configuration of supported functionality is provided in Step 3, is for further study. The additional Layer 1/Layer 2 (L1/L2) signaling for activation/deactivation is for further study. Whether multiple applicable functionalities may be activated at the same time is for further study. The granularity of the functionality is for further study.

In RAN2 #127bis meeting, the following agreements were made for beam management:
1. UAI is supported and RRCReconfigurationComplete message may be used to report applicable functionality. The design should be aligned on how the applicable functionalities are signaled. The applicability reporting content is for further study.
2. Whether inference configuration may be signaled in Step 3 of FIG. 2 is for further study.
3. The UE may report to the network when an applicable AI functionality becomes non-applicable. How this is signaled (e.g., explicitly/implicitly) is for further study. Considering different scenarios, whether it is regarding an active functionality.
4. Data collection initiation and configuration for data collection is under the network control. How the network determines whether data collection should be initiated (e.g., via UE requests (UE directly or UE server)) is for further study.
5. For the purpose of discussion of AI/ML BM LCM operations, the existing procedures and terminologies from the CSI Framework should be used, including those defined for aperiodic, semipersistent on PUCCH, semipersistent on PUSCH, and periodic reporting configurations (as defined in RAN1 pending response LS from RAN1).
6. For now, RAN2 may not define terminology specific to the activation or deactivation for the AI/ML models but may come back to this discussion later.

RAN2 has not addressed the following problems. What happens if the functionality becomes inapplicable after activation? How activation/deactivation ping pong may be avoided and how a stable applicable functionality for a certain time duration may be achieved? How to reduce frequent activation/deactivation signaling?

An issue that is not addressed by RAN2 is the ping pong phenomenon in the activation and deactivation of functionality, which refers to a situation where a functionality repeatedly turns on and off due to fluctuating additional conditions. This may create confusion and inefficiencies in the UE and may negatively impact user experience. It may also lead to additional signaling between the UE and the network. This issue involves the risk of unnecessary switching between the AI/ML and non-AI/ML modes.

Another issue that is not addressed by RAN2 arises when the UE is performing inference operations that are configured or activated by the network in Step 6 of FIG. 2. Once the functionality is activated, there are potential risks regarding the applicability of the ongoing functionality due to dynamic changes in the UE's internal conditions such as the UE's computational resources and battery charge state. RAN2 does not define the UE behavior if the functionality becomes inapplicable after activation.

RAN2 also does not describe under what conditions the inference by the UE should be stopped. Continuing the inference with degraded performance and whether the UE should attempt to continue the inference operation even if it means reduced accuracy or increased latency is also not addressed by RAN2.

RAN2 also does not describe how the UE should handle such a failure to ensure no critical data is lost. For example, the following deactivation scenarios may be used: (1) Fallback to Legacy—If only one functionality per sub-use case is activated, deactivation would mean reverting to the legacy (non-AI/ML) method, (2) Partial Fallback—If multiple functionalities may be active simultaneously, deactivation might involve falling back to legacy for only the set of beams previously predicted by the deactivated functionality, while other AI/ML functionalities remain active, and (3) Switching Functionalities—If allowed, deactivation could also mean switching to another active functionality to predict the same set of beams.

When a functionality becomes inapplicable after activation due to not meeting the criteria, a new applicable functionality report may be sent from the UE to the BS (e.g., gNB), prompting the BS to make a decision. The BS may take several actions depending on the importance of the functionality: (1) deactivate the activated AI/ML functionality, (2) deactivate the AI/ML functionality and simultaneously activate a different AI/ML functionality, or (3) deactivate the AI/ML functionality and simultaneously activate a non-AI/ML feature.

The Lenovo approach described in document R2-2408312, uses a prohibit timer. The UE may send a UAI message indicating a UE sided AI functionality becomes non-applicable at any time without restriction (e.g., prohibit timer). The UE may be configured with a prohibit timer that after the UE reports via the UAI that a UE sided AI functionality becomes non-applicable, the UE may not send another UAI message for the same UE-sided AI functionality within a time period.

The Apple approach described in the document R2-2408563 makes the following observation. When the UE is performing inference operation configured/activated by the network (NW) in Step 6, it is possible that the on-going functionality may become non-applicable due to insufficient memory or insufficient battery for inference operation. The UE behavior following this event is not clear (e.g., whether inference may be stopped). Because the UE's memory and battery status may change dynamically, it is not a corner case. Thus, the UE behavior needs to be clearly specified.

The technical problem to be solved is that the BS wants to avoid the case where the UE automatically deactivates a functionality due to the non-applicability of the functionality during the BS communicates with the UE using the activated functionality.

As noted in the RAN1, CSI reports for both beam management-Case1 (BM-Case1) and BM-Case2 may be triggered on-demand using either DCI for aperiodic reporting or MAC CE for semi-persistent reporting. These functionalities are activated via DCI or MAC CE and deactivated automatically at the end of the reporting. The switching or fallback between functionalities is managed implicitly through the selection of which report to activate.

### Standardized UE Side Associated ID

As shown in Step 4 of FIG. 2, the UE may determine and report applicable functionalities to the network. The applicability of a functionality may be determined by several factors such as the network side additional conditions, the UE side additional conditions, inference configuration, environmental factors, etc.

When determining the applicable functionalities, the UE and the network may need to determine the stability of an applicable functionality, for example, the probability of how long a functionality may remain applicable. In some embodiments, the UE may generate a UE side associated ID, which may be used to indicate UE side conditions to the network. As an example, the UE side associated ID may be created as an index considering, for example, the UE power consumption, memory storage and other associated hardware requirements (including the hardware requirements for given processing delays), graphics processing unit/central processing unit (GPU/CPU) frequency, computation power of the CPU or GPU (e.g., floating-point operations per second (flops)) required for each functionality, such as, CSI enhancement, beam management, and/or beam positioning, etc., supported by the UE.

Other parameters that may be considered for generating the UE side associated ID may include:
The UE side AI/ML model availability and related information
Inference configuration if provided by the network
The remaining processing power in flops
The remaining processing power in percentage of total processing capabilities.
The process power may consider the model complexity and batter power etc.
Model size and number of models applied
The current number of activated and/or applicable functionalities, etc.

The UE side Associated IDs are identifiers assigned to each UE that represent the UE's specific conditions, states, and internal capabilities (e.g., battery status and power consumption, processing power, mobility patterns, etc.). It should be noted that these parameters are indicated herein as examples, as any additional parameters or combination of parameters may also be used for determination of the UE side associated IDs.

In some embodiments, if the network side additional conditions are provided to the UE in the form of NW-side associated IDs, the UE may take that information into account to compute the UE side Associated IDs.

### Simple Implementation Example

A non-limiting example of the UE side associated ID or index computation is described below. A score may be assigned to each state based on the state's desirability. For simplicity, the following example uses a scoring range of 0 to 100.

### 1. Battery Level (B)

High (≥80%): 100
Medium (50%-79%): 70
Low (20%-49%): 40
Critical (<20%): 0

### 2. Computational Resources (C)

Low (≤30% CPU Usage): 100
Moderate (31%-70%): 70
High (>70%): 30

### 3. Environmental Conditions and Mobility (E)

Excellent (e.g., urban environment, low mobility speed): 100
Good (e.g., mixed urban/rural, moderate mobility speed): 80
Fair (e.g., rural environment, high mobility speed): 50
Poor (e.g., harsh environments, extreme mobility conditions): 0

The parameters in the above example may also be considered over a time interval (either observed or predicted). For example, the minimum value of battery level (or power consumption) over the interval may be taken, as it represents the worst-case scenario for battery levels/power consumption. The maximum CPU usage over the interval may be taken, as it may indicate the peak load on resources and thus a worst-case computational condition. In some embodiments, the worst observed condition within the interval may be selected, reflecting the most challenging environmental situation and mobility level. The parameters may also be averaged over time. The time-interval (observed or predicted) may be configured by the network or as per implementation.

### Calculation of the Combined Score

To compute a single metric, a weighted average or simple average may be used. For simplicity, the following example uses a simple average, assuming equal weight for each condition:

$$Combined Score = ( {S}_{B} + {S}_{C} + {S}_{E} ) / 3$$

### Where:

S_{B}=Score for Battery Level
S_{C}=Score for Computational Resources.
S_{E}=Score for Environmental Conditions and Mobility

The given Conditions are as follows:
Battery Level: Medium (Score=70)
Computational Resources: High (Score=30)
Environmental Conditions and Mobility: Good (Score=80)

The combined score may be calculated as follows:

$$Combined Score = ( 70 + 30 + 80 ) / 3 = 180 / 3 = 60$$

To map this score to an index from 1 to 10, the following formula may be used:
The UE side associated ID=(Combined Score)/10

For a combined score of 60, the index may be calculated as follows:
The UE side associated ID=60/10=6

The final results are as follows:
Battery Level: Medium (Score: 70)
Computational Resources: High (Score: 30)
Environmental Conditions and Mobility: Good (Score: 80)
Combined Score: 60
The UE side associated ID: 6 (e.g., above average probability)

The UE side associated ID together with the network side conditions or the NW-side associated IDs allow for easier integration of the UE conditions into the model, ensuring that both training and inference phases reflect the same internal states, facilitating accurate predictions. This may further help in maintaining consistency between AI/ML model training and inference.

In some embodiments, the UE side associated ID may be linked per network side associated ID. The UE may also have multiple UE side associated IDs per network side associated ID and may switch between them, when necessary, based on the UE side conditions, environmental factors etc. For example, the UE side associated ID A may be mapped to the network side associated ID X and the UE side associated ID B may be mapped to the network side associated ID Y.

### Multiple UE Side Associated ID for a Single NW-Side Associated ID and Vice-Versa

A single network side associated ID (e.g., an associated ID for a base station) may be linked to the UE side associated ID. This allows different UEs connected to the same network resource to be managed based on their specific conditions. Also, multiple network side associated IDs may be linked to a single UE side associated ID.

For example, if a base station serves multiple UEs, each UE may have its unique UE side associated ID reflecting its internal state (battery level, CPU usage, etc.) and environmental conditions (urban, rural, etc.). A mapping table may be maintained by the UE and/or the network to link each network side ID to the corresponding UE associated side IDs.

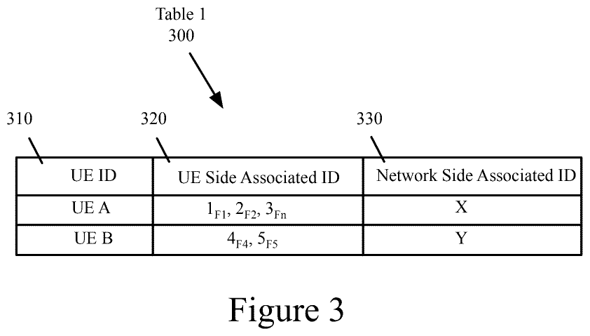

FIG. 3 illustrates a table 300 that shows an example mapping of each UE 310 to the corresponding UE side associated IDs 320 and the corresponding network side associated ID 330, according to an example implementation of the present disclosure. In the example of FIG. 3, table 300 illustrates that the UE side associated ID 1 belongs to UE A and is linked to a (sub)functionality F1 (e.g., CSI configuration) or a (sub)use-case (e.g., Beam Management), etc., reflecting also the associated AI/ML model and related information. The UE side associated ID 1 is then linked to the network side associated ID X that reflects the network side additional conditions. Similarly, the UE side associated ID 4 of UE B is linked to the network side associated ID Y, etc.

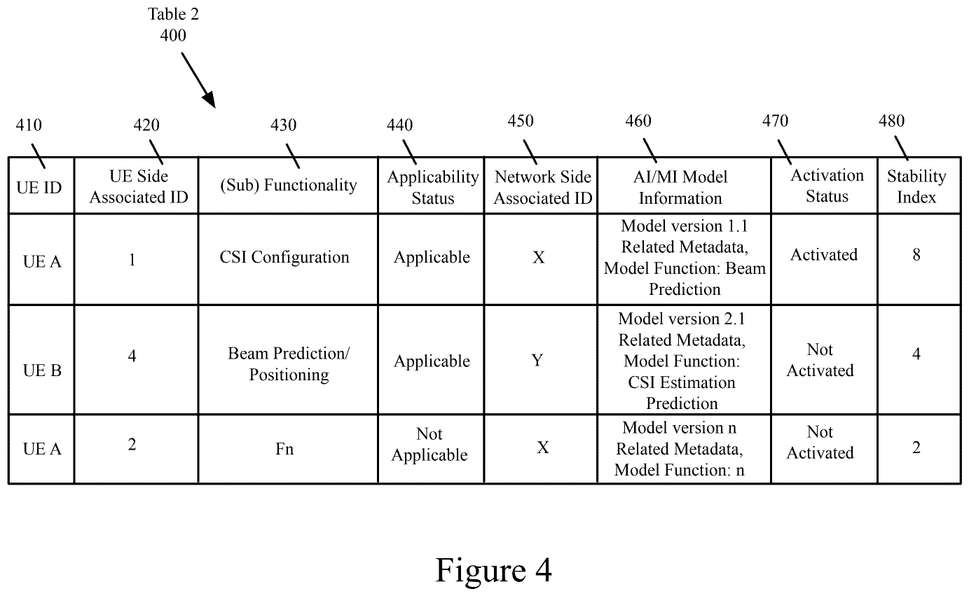

FIG. 4 illustrates a table 400 that shows an example mapping of each UE 410 to a corresponding set of parameters 420-480, according to an example implementation of the present disclosure. In the example of FIG. 4, table 400 illustrates that each UE 410 may be mapped to the corresponding UE side associated ID 420, the functionality or sub functionality 430, the applicability status 440 of the functionality or sub functionality, the network side associated ID 450, the AI/ML model information 460, the activation status 470 of the functionality or sub functionality, and the stability index 480. The stability index is described below.

The UE may report the UE side Associated ID 420 and/or the stability index 480 to the network, which may be used by the network to decide which applicable functionalities may be activated. The granularity of the UE side associated ID 420 may be per functionality, sub-functionality, or per functionality configuration. For example, for the Beam Management use case, granularity of the UE side associated ID may be per CSI-MeasConfig and CSI-Reportconfig, CSI-RS configuration and Reporting combinations.

### Applicable Functionality Stability Index

In some embodiments, the UE may calculate a variable, referred to herein, as the applicable AI functionality stability index (or the stability index). The stability index may be calculated using the UE side internal conditions, the environmental factors, and other related factors. With the help of the stability index, the UE or the network may determine the probability (or the estimation) of how long a functionality may be applicable (e.g., ready to be activated) if not activated and how long the functionality may stay activated once it is activated. This may be done, for example, by using two variables: AI functionality stability index activated (e.g., after activation) and AI functionality stability index without activation.

Once the UE determines the stability index, the UE may report it to the network together with applicable functionality report in Step 4 of FIG. 2, or in a separate message. The stability index may be computed based on prediction models.

The granularity of the stability index may be per functionality, sub-functionality, or per functionality configuration. For example, for Beam Management use case it may be per CSI-MeasConfig and CSI-Reportconfig, CSI-RS configuration and Reporting combinations. The stability index may be quantized, for example, to a value between 1 to 10, with 1 being the least stable and 10 being the most stable.

The parameters below are listed as an example. Any additional parameters or combination of parameters may also be used for the determination of the stability index. For example, inference configuration may also be utilized if offered by the network. Additionally, the UE may leverage its internal assessment to determine the minimum duration it may support a functionality after activation, considering its internal conditions, resource usage, resource availability, etc.

### Sample Calculations for Determining Probability-Based Stability Index

The followings are examples of the parameters that may be considered for determining the stability index:
1. Battery level (B): B≥Bₘᵢₙ
2. Computational resources (C): C≤Cₘₐₓ
3. Network side additional conditions (may be in the form of associated IDs) (N): N≥Nₘᵢₙ
4. Environmental conditions (E): Urban, Rural, Macro
5. Mobility (M): Speeds of 30 km/h, 60 km/h, and 90 km/h.

The minimum value of the battery level (or power consumption) over an interval may be considered, as it may represent the worst-case scenario for battery levels/power consumption. The maximum CPU usage over the interval may be considered, as it may indicate the peak load on resources and thus a worst-case computational condition. The worst observed conditions within the interval may then be selected, reflecting the most challenging environmental situation and mobility level. The parameters may then also be averaged over time. The time-interval (observed or predicted) may be configured by the network or as per individual implementation.

### Modeling the Probabilities

The overall probability may be calculated as a combination of the battery level/power consumption, computational resources, network side additional conditions, environmental conditions, and mobility conditions:

$$P ( F ) = P ( B \geq B min ) \times P ( C \leq C max ) \times P ( N \geq N min ) \times P ( E ) \times P ( M )$$

As a next step, the probabilities for different speeds in different environments may be assigned. Each of the following scenarios considers different moving speeds of the UE in different environments (e.g., urban, rural, and macro environments):
1. Urban Environment:
   Stationary: P(M)=0.85
   Moving:
      30 km/h: P(M)=0.70
      60 km/h: P(M)=0.60
      90 km/h: P(M)=0.50
2. Rural Environment:
   Stationary: P(M)=0.90
   Moving:
      30 km/h: P(M)=0.80
      60 km/h: P(M)=0.70
      90 km/h: P(M)=0.60
3. Macro Environment:
   Stationary: P(M)=0.95
   Moving:
      30 km/h: P(M)=0.85
      60 km/h: P(M)=0.75
      90 km/h: P(M)=0.65

### Calculating Overall Probability

The probability for each combination of the environment and speed may then be calculated as follows:

### Urban Environment

1. Stationary:

$$P ( F ) = 0.80 \times 0.70 \times 0.95 \times 0.60 \times 0.85 = 0.2876$$

2. Moving (30 km/h):

$$P ( F ) = 0.80 \times 0.70 \times 0.95 \times 0.60 \times 0.70 = 0.2464$$

3. Moving (60 km/h):

$$P ( F ) = 0.80 \times 0.70 \times 0.95 \times 0.60 \times 0.60 = 0.2104$$

4. Moving (90 km/h):

$$P ( F ) = 0.80 \times 0.70 \times 0.95 \times 0.60 \times 0.50 = 0.1752$$

### Rural Environment

1. Stationary:

$$P ( F ) = 0.85 \times 0.80 \times 0.80 \times 0.25 \times 0.90 = 0.1360$$

2. Moving (30 km/h):

$$P ( F ) = 0.85 \times 0.80 \times 0.80 \times 0.25 \times 0.80 = 0.1088$$

3. Moving (60 km/h):

$$P ( F ) = 0.85 \times 0.80 \times 0.80 \times 0.25 \times 0.70 = 0.0944$$

4. Moving (90 km/h):

$$P ( F ) = 0.85 \times 0.80 \times 0.80 \times 0.25 \times 0.60 = 0.0816$$

### Macro Environment

1. Stationary:

$$P ( F ) = 0.90 \times 0.75 \times 0.85 \times 0.15 \times 0.95 = 0.0864$$

2. Moving (30 km/h):

$$P ( F ) = 0.90 \times 0.75 \times 0.85 \times 0.15 \times 0.85 = 0.0770$$

3. Moving (60 km/h):

$$P ( F ) = 0.90 \times 0.75 \times 0.85 \times 0.15 \times 0.75 = 0.0676$$

4. Moving (90 km/h):

$$P ( F ) = 0.90 \times 0.75 \times 0.85 \times 0.15 \times 0.65 = 0.0582$$

### Calculating Total Probability

The overall probability for the combination of the environment and speed may then be calculated by summing the probabilities for all combinations of environments and mobility states:

$$P ( F ) total = {P ( F )}_{urban , stationary} + {P ( F )}_{urban , 30 km / h} + {P ( F )}_{urban , 60 km / h} + P ( F ) urban {,}_{90 km / h} + {P ( F )}_{rural , stationary} + {P ( F )}_{rural , 30 km / h} + {P ( F )}_{rural , 60 km / h} + {P ( F )}_{rural , 90 km / h} + {P ( F )}_{macro , stationary} + {P ( F )}_{macro , 30 km / h} + {P ( F )}_{macro , 60 km / h} + {P ( F )}_{macro , 90 km / h}$$

The step-by-step calculation is as follows:
Urban:
   Stationary: 0.28760
   30 km/h: 0.24640
   60 km/h: 0.21040
   90 km/h: 0.17520

### Total Urban:

$$0.2876 + 0.2464 + 0.2104 + 0.1752 = 0.91960.2876 + 0.2464 + 0.2104 + 0.17 \; 52 = 0.9196 \text{.2876} + 0.2464 + 0.2104 + 0.1752 = 0.9196$$

Rural:
   Stationary: 0.13600
   30 km/h: 0.10880
   60 km/h: 0.09440
   90 km/h: 0.08160

### Total Rural:

$$0.1360 + 0.1088 + 0.0944 + 0.0816 = 0.4208 0.1360 + 0.1088 + 0.0944 + 0.08 \; 16 = 0.4208 0.1360 + 0.1088 + 0.0944 + 0.0816 = 0.4208$$

Macro:
   Stationary: 0.08640
   30 km/h: 0.07700
   60 km/h: 0.06760
   90 km/h: 0.05820

### Total Macro:

$$0.0864 + 0.0770 + 0.0676 + 0.0582 = 0.2892 0.0864 + 0.0770 + 0.0676 + 0.05 \; 82 = 0.2892 0.0864 + 0.0770 + 0.0676 + 0.0582 = 0 \text{.2892}$$

### Calculating the Final Total Probability

The total probability for all environmental scenarios may then be calculated as follows:

$$P ( F ) total = 0.9196 + 0.4208 + 0.2892 = 1.6296 = 0.9196 + 0.4208 + 0.2892 = 1.6296$$

### Converting the Probability to Index

Since the total probability exceeds 1 due to the summation of individual probabilities, the total should be normalized by the number of scenarios considered (which is 11 in the above example):

$$P ( F ) average = ( P ( F ) total ) / 11 = 1.6296 / 11 \approx 0.1482$$

This may also be understood in terms of the overall applicability across all environments and speeds.

Using the defined index scale the probability may be expressed as a percentage:

$$P ( F ) average \approx 0.1482 or ( or 14.82 \% )$$

The resulting probability falls within the range of 11% to 30%, so the index may be converted to the integer value 2 (e.g., Low Probability).

### Calculating Average Probability for Each Environment

The average probability for each environment may be calculated as follows:

### Urban Environment

$${P ( F )}_{urban} = 0.2876 + 0.2464 + 0.2104 + 0.17524 = ( 0.91964 ) / 4 = 0.2299$$

### Rural Environment

$${P ( F )}_{rural} = 0.1360 + 0.1088 + 0.0944 + 0.08164 = 0.42084 = 0.1052$$

### Macro Environment

$${P ( F )}_{macro} = 0.0864 + 0.0770 + 0.0676 + 0.05824 = 0.28924 = 0.0723$$

The average probability may then be converted to an index using a defined index scale:
Urban Environment: P(F)urban=0.2299 (or 22.99%)
   This falls within the range of 21% to 30%, so the index is 2 (Low Probability).
Rural Environment: P(F)rural=0.1052 (or 10.52%)
   This falls within the range of 0% to 10%, so the index is 1 (Very Low Probability).
Macro Environment: P(F)macro=0.0723 (or 7.23%)
   This falls within the range of 0% to 10%, so the index is 1 (Very Low Probability).

With the help of the stability index, the network may determine which applicable functionality has the highest probability to remain applicable and it may help network sort and activate the applicable functionality(s). Both the UE side associated ID and the stability index may be computed at the UE or network.

In some embodiments, the stability index may also be computed such that it reflects the UE's confidence level in the accuracy or reliability of the inference results. For this purpose, variables or parameters associated with a specific functionality may be used such as functionality monitoring KPIs, past performance etc.

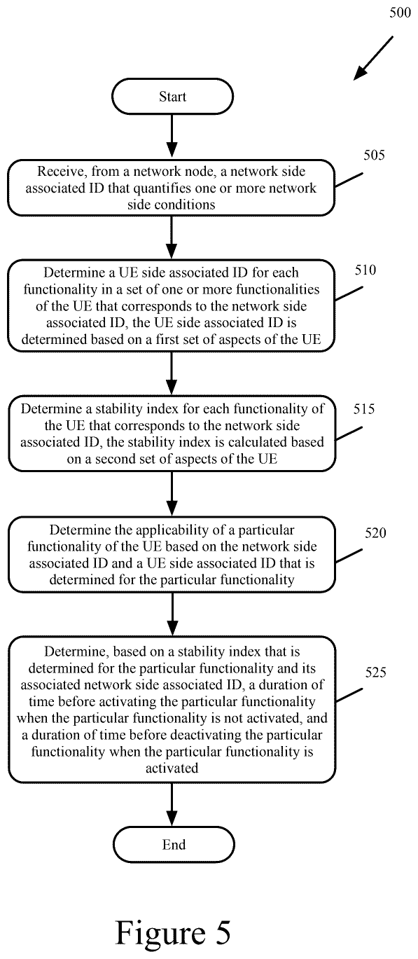

FIG. 5 is a flowchart illustrating an example method/process 500 performed by a UE for determining one or more UE side associated IDs and one or more stability indexes, according to an example implementation of the present disclosure. The process 500 may be performed by at least one processor of a UE 101A-101C, shown in FIG. 1.

The process 500 may receive (at block 505), from a network node, a network side associated ID that quantifies one or more network side conditions. For example, the network side associated ID may quantify one or more of (i) mapping relationship of Set A and Set B, including ordering to a set of identifications (IDs), or resources, (ii) consistency of downlink spatial domain transmission filters corresponding to the beams in Set A and Set B, (iii) QCL assumption, (iv) the order of model input and model output between the Rx and Tx beams, which can be pre-defined, (v) transmission power, (vi) UE distribution, (vii) antenna height, (viii) deployment scenarios (e.g., ISD, Umi/Uma), and (ix) ensuring consistency across different cells.

The process 500 may determine (at block 510) a UE side associated ID for each functionality in a set of one or more functionalities of the UE that corresponds to the network side associated ID. The UE side associated ID may be determined based on a first set of aspects of the UE. The first set of aspects of the UE, in some embodiments, may include at least a UE hardware resource from several UE hardware resources required for performing the corresponding functionality of the UE, the mobility of the UE, or the type of the environment where the UE is located. The UE hardware resources may include, for example, one or more of the UE power consumption, the memory storage of the UE, the operating frequency of a GPU of the UE, and the operating frequency of the processor of the UE.

In some embodiments, the UE side associated ID may be determined as a function of a score for the battery level of the UE, a score for the availability of computational resources of the UE, a score for environmental conditions and mobility of the UE, and a score on the past effectiveness of the corresponding functionality. The effectiveness of each functionality, in some embodiments, may be evaluated and stored to be used as one of the scores for determining the UE side associated IDs. The UE side associated ID may be determined by mapping a value generated by the function into one of several values in a predetermined range of values. The function, in some embodiments, may be a non-weighted average or a weighted average.

The process 500 may determine (at block 515) a stability index for each functionality of the UE that corresponds to the network side associated ID. The stability index may be calculated based on a second set of aspects of the UE. Each functionality of the UE, in some embodiments, may be an artificial AI/ML functionality that the UE is ready to apply for AI/ML model inference or an AI/ML functionality that the UE supports based on UE capabilities. Each stability index may specify a probability that the corresponding UE functionality remains applicable for a time interval after the UE functionality is activated or a probability that the UE functionality remains applicable for a time interval prior to the UE functionality being activated. Each functionality of the UE, in some embodiments, may provide a set of inference results and the stability index may quantify the UE's confidence level in the accuracy or reliability of the set of inference results.

The second set of aspects of the UE, in some embodiments, may be at least a UE hardware resource from several UE hardware resources required for performing the corresponding functionality of the UE, the mobility of the UE, or the type of the environment where the UE is located. The stability index, in some embodiments, may be determined by calculating a function of the probability of occurrence of each aspect in the second set of aspects of the UE.

The stability index, in some embodiments, may be determined by calculating several probabilities for different moving speeds of the UE in different environments, summing the probabilities, and calculating a normalized probability by dividing the sum of the f probabilities by the number of probabilities. In some embodiments, the stability index corresponding to a functionality of the UE may be determined by calculating the probability that the battery level of the UE is above a threshold and calculating the probability that the computational resources required for performing the functionality of the UE is below a threshold.

The process 500 may determine (at block 520) the applicability of a particular functionality of the UE based on the network side associated ID and a UE side associated ID that is determined for the particular functionality. The process 500 may determine (at block 525), based on the stability index that is determined for the particular functionality and its associated network side associated ID, a duration of time before activating the particular functionality when the particular functionality is not activated, and a duration of time before deactivating the particular functionality when the particular functionality is activated. The process 500 may then end.

The process 500, in some embodiments, may maintain a mapping of the identification of the UE, the UE side associated ID, the network side associated ID representing the one or more network side conditions, the UE functionalities, the applicability status of each UE functionality, the activation status of each UE functionality, and the stability index. For example, the process 500 may maintain a table, such as Table 400, shown in FIG. 4.

The process 500, in some embodiments, may receive, from the network node, a set of one or more other network side associated IDs. Each network side associated ID in the set of one or more network side associated IDs may quantify one or more network side conditions. The process 900 may determine the applicability of the particular functionality of the UE further based on the set of one or more network side associated IDs.

### Procedure for Exchange of the UE Side Associated ID and the Stability Index Between the UE and the Network

Some embodiments provide several scenarios for exchanging the UE side associated ID and the stability index between a UE and the network. In a first scenario, the UE may decide the applicable functionalities. In a second scenario, the network may decide the applicable functionalities. In a third scenario, the UE and the network may jointly decide the applicable functionalities.

### Scenario 1—The UE Decides the Applicable Functionalities

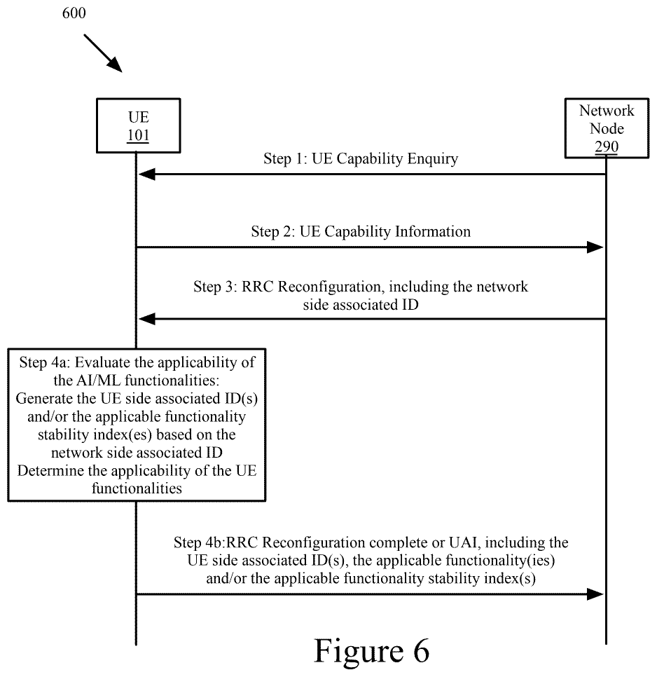

FIG. 6 is a sequence diagram 600 illustrating an example message flow of a signaling framework in which the UE decides the applicable functionalities, according to an example implementation of the present disclosure. The wireless communications system may be, for example, a 3GPP network, such as, the 5G/5G-A or the 6^{th} generation (6G) NR system. The UE 101 may be any of the UEs 101A-101C and the network node 290 may be the BS 103 shown in FIG. 1 or any other network entity, for example, an LMF server.

With reference to FIG. 6, Step 1 and Step 2 may be similar to Step 1 and Step 2 shown in FIG. 2, respectively. In Step 3, the UE 101 may receive the network side associated ID from the network node 290, for example, in an RRC Reconfiguration message.

The UE 101 may evaluate the applicability of the AI/ML functionality(ies) in Step 4a. The UE 101, in Step 4a, may generate the UE side associated ID(s) and/or the stability indexes as described above. The UE 101 may determine the applicability of one or more functionalities of the UE based on the UE side associated IDs.

In Step 4b, the UE 101 may report the applicable functionality(ies), the UE side associated IDs, and/or the stability index(es) to the network node, for example, using UAI or RRC signaling, as required by the network. The exact signaling to be used may be indicated by the network in Step 3, or it may be left to the UE implementation.

The embodiment of FIG. 6 provides the advantage that the UE, which is better aware of the UE side conditions than the network, makes the decision for the selection of applicable functionalities. The UE 101 may determine the applicable functionalities and may report the applicable functionalities to the network node 290. The network node 290 may decide which functionalities to activate based on the, for example, the UE side associated ID, the stability index, the network side conditions, the available functionality configurations, etc., or one or more combination of these. In some embodiments, the UE 101 may be configured by the network node to activate or deactivate the applicable functionalities and report the activation or deactivation to the network node 290.

### Scenario 2—The Network Decides the Applicable Functionalities

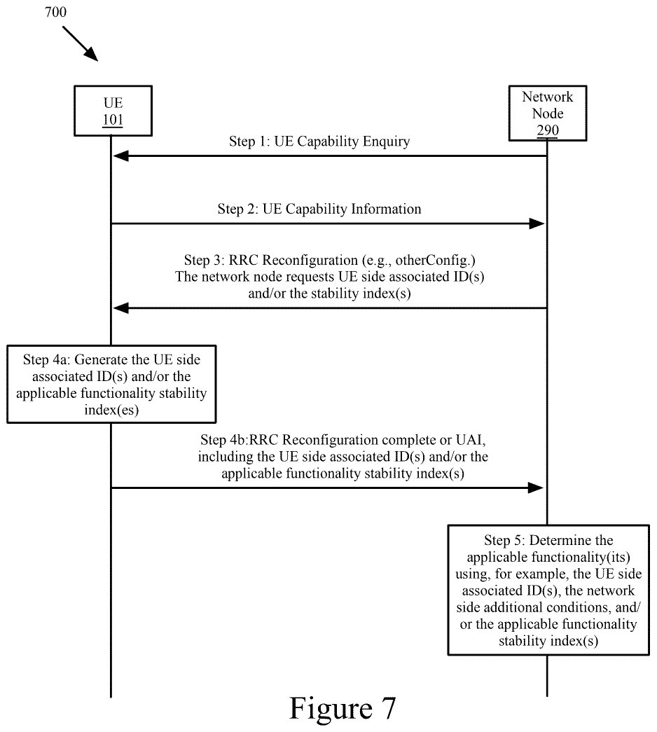

FIG. 7 is a sequence diagram 700 illustrating an example message flow of a signaling framework in which the network decides the applicable functionalities, according to an example implementation of the present disclosure. The wireless communications system may be, for example, a 3GPP network, such as, the 5G/5G-A or the 6^{th} generation (6G) NR system. The UE 101 may be any of the UEs 101A-101C and the network node 290 may be the BS 103 shown in FIG. 1 or any other network entity, for example, an LMF server. In the embodiment of FIG. 7, the UE may report the UE side associated ID(s) and the network decides the applicable functionality(s) using UE side associated ID(s) and the network side additional conditions.

With reference to FIG. 7, Step 1 and Step 2 may be similar to Step 1 and Step 2 shown in FIG. 2, respectively. In Step 3, the network node 290 may request the UE side associated ID(s) and/or the stability index(s) from the UE 101.

In step 4a, the UE 101 may generate the UE side associated ID(s), for example, by using the UE internal conditions, environmental conditions, inference configuration (if provided by the network). The UE 101 may also generate stability index(s) (e.g., the probability of how long a functionality may remain applicable).

In step 4b, the UE 101 may report the UE side associated ID(s) and the stability index(s) to the network node 290, for example, by using UAI or RRC signaling, as required by the network. In Step 5, the network node 290 may determine the appliable functionality(s) by using, for example, the UE side associated ID(s), the network side additional conditions, and/or the stability index. The network may then decide which functionality(s) to (de)activate using the stability index. In some embodiments, a filter may be applied to the functionalities. For example, if the stability index is very low, the UE or the network may choose to discard the functionality, even if it is technically applicable.

In some embodiments, if the network node wants to activate a specific functionality but finds that its stability index is low (e.g., the functionality may soon become unavailable and may need to be de-activated), the network may request the UE to adjust the UE's settings and/or internal conditions. By doing so, the UE may improve the stability index and may ensure a more reliable functionality. The UE may then report the improved stability index of the intended functionality to the network.

In some embodiments, if the network activates a functionality with a low stability index, or if the stability index of a functionality changes between the reporting of applicable functionalities and its activation, the UE may reject the activation. In such cases, the UE may request reconfiguration or an alternative activation of the functionality.

### Scenario 3—The UE and the Network Jointly Decide the Applicable Functionalities

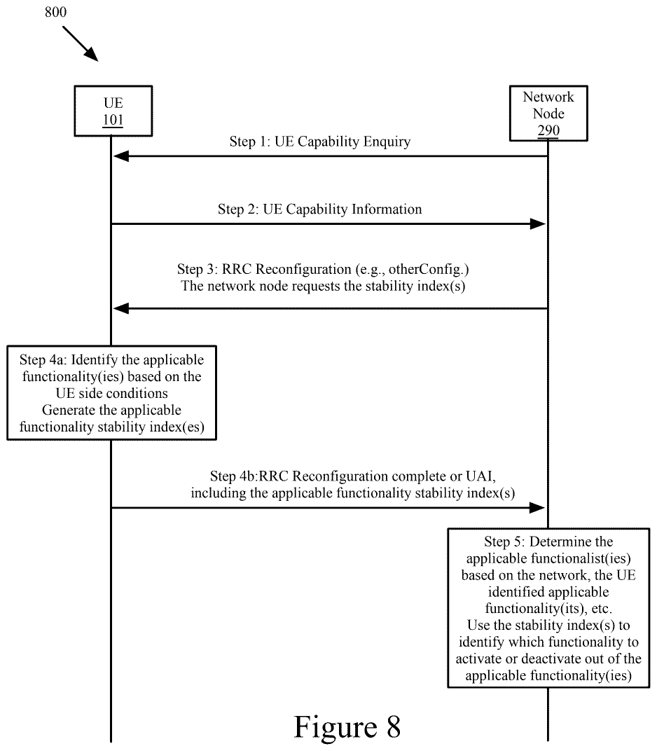

FIG. 8 is a sequence diagram 800 illustrating an example message flow of a signaling framework in which the UE and the network jointly decide the applicable functionalities, according to an example implementation of the present disclosure. The wireless communications system may be, for example, a 3GPP network, such as, the 5G/5G-A or the 6th generation (6G) NR system. The UE 101 may be any of the UEs 101A-101C and the network node 290 may be the BS 103 shown in FIG. 1 or any other network entity, for example, an LMF server.

With reference to FIG. 8, Step 1 and Step 2 may be similar to Step 1 and Step 2 shown in FIG. 2, respectively. In Step 3, the network node 290 may request the stability index(s) from the UE 101.

In step 4a, the UE 101 may identify the applicable functionality(ies) based on, for example, the UE side internal conditions, environment conditions, inference configuration (if provided), etc. The UE may generate the stability index(es) for the identified applicable functionality(ies). In step 4b, the UE 101 may report the applicable functionality(ies) and the stability index(s) to the network node 290, for example, by using UAI or RRC signaling, as required by the network.

In step 5, the network node 290 may determine the applicable functionality(ies) based on the UE provided inputs such as applicable functionality(ies) identified by the UE, the network side additional conditions, and/or stability index provided by the UE. The network node 290 may then decide which functionality(s) to (de) activate using the stability index. In some embodiments, the network node 290 may switch on and off stability index/UE side associated ID reporting using L1/L2 signaling (e.g., MAC CE or DCI).

It should be noted that the granularity of the UE side associated ID and/or stability index may be per functionality, sub-functionality, or per functionality configuration. For example, for the Beam Management use case the granularity may be per CSI-MeasConfig. and CSI-Reportconfig, CSI-RS configuration and Reporting combinations.

For requesting and reporting the UE side associated ID and stability index, enhanced CSI report config/CSI measConfig, or enhanced UAI/RRC messages may be used. Other L1/L2/L3 or a new message may also be used for implementation. For example, for requesting the UE side associated ID and/or the stability index, CSI measConfig, RRC, MAC CE etc., may be used and for reporting from the UE to the network UAI message, CSI report, RRC etc., messages may be used.

It should be noted that the applicability of a functionality may still change due to external factors which may not be in control of the UE or the network.

The following is an example of an enhanced RRC message according to some embodiments:

```
RRCReconfiguration {
  radioBearerConfig {
  ... // other bearer configurations
  }
  csi-MeasConfig {
  nzp-CSI-RS-ResourceToAddModList {
    nzp-CSI-RS-Resource {
    resourceId: <resource_ID>,
    frequencyDomainAllocation: <value>,
    resourceMapping {
      firstSymbol: <value>,
      symbolLength: <value>,
      firstSubcarrier: <value>,
      subcarrierSpacing: <value>
    },
    periodicityAndOffset: <periodicity_value>,
    nrofPorts: <number_of_ports>,
    csi-RS-PowerControlOffset: <value>
    }
  },
  csi-ReportConfigToAddModList {
    csi-ReportConfig {
    reportConfigId: <report_config_ID>,
    csi-IM-ResourceSetList: {
      csi-IM-ResourceSet {
      resourceSetId: <resource_set_ID>,
      resources: { <list_of_csi_im_resources> }
      }
    },
    csi-ResourceConfig {
      nzp-CSI-RS-ResourceSetId: <nzp_resource_set_ID>,
      csi-SINR-Threshold: <threshold_value>,
      csi-MeasPeriodicity: <periodicity>,
      csi-MeasurementBandwidth: <bandwidth_value>
    },
    csi-ReportQuantity {
      cqi-FormatIndicator: <wideband | subband>,
      pmi-FormatIndicator: <value>,
      ri-FormatIndicator: <value>
    },
    csi-ReportMode {
      reportType: <periodic | aperiodic>,
      reportingTrigger: <trigger_value>
    },
    periodicity: <report_periodicity_in_ms>,
    aperiodicTriggering: <trigger_setup_value>
    }
  }
  }
  measGapConfig {
  ... // measurement gap configuration, if applicable
  }
  mobilityControlInfo {
  ... // mobility configuration, if applicable
  }
UE side Associated ID { UE side additional conditions
      Stability Index: <value> // Value between 1 (low) and 10
      (high) as per configuration
  }
}
```

The following is an example of an enhanced RRCReconfigurationComplete message according to some embodiments:

```
RRCReconfigurationComplete {
  rrcTransactionIdentifier: <transaction_ID>, // Matching the transaction
ID from the initial RRCReconfiguration message
  criticalExtensions {
  c1 {
    rrcReconfigurationComplete {
    measResults {
      csi-Report {
      cqi: <value>, // CQI feedback (e.g., 15 for good channel quality)
      pmi: <value>, // Preferred PMI (precoding matrix index)
      ri: <value>, // Rank indicator (e.g., 2 for 2x2 MIMO)
      }
    },
    UE side Associated ID { UE side additional conditions
      Stability Index: <value> // Value between 1 (low) and 10 (high) as
      per configuration
    }
    }
  }
  }
}
```

The following is an example of an enhanced CSI Report message according to some embodiments:

UECSIReport {

| | |
|---|---|
| csiReportConfigId: 5, | // Identifier of the CSI report configuration from the RRC message |

cqiReport {

| | |
|---|---|
| widebandCQI: 15, | // CQI feedback, indicating high channel quality (CQI scale: 0-15) |

```
  },
  pmiReport {
```

| | |
|---|---|
| pmiIndex: 3, | // Preferred PMI for beamforming (Precoding Matrix Index) |

```
  },
  riReport {
```

| | |
|---|---|
| rankIndicator: 2, | // RI (Rank Indicator) - Number of spatial streams (e.g., 2x2 MIMO) |

```
  },
  liReport {
```

| | |
|---|---|
| layerIndicator: 2, | // Number of transmission layers (based on MIMO configuration) |

```
  },
  inferenceReport {
```

| | |
|---|---|
| UE side Associated ID: 9, | // Reflecting UE internal conditions, with 9 indicating high |

performance (scale: 1-10)

| | |
|---|---|
| Stability Index: 8, | // Confidence in the inference result and/or applicable functionality, with 8 |

```
indicating high confidence (scale: 1-10)
  },
  timingAdvanceReport {
```

| | |
|---|---|
| timingAdvance: 64, | // Example timing advance value for synchronization |

```
  },
  harqFeedback {
```

| | |
|---|---|
| harqProcessId: 1, | // Hybrid ARQ process ID |
| harqAcknowledgement: ACK | // HARQ feedback (ACK/NACK) |

}
}

The following is an example breakdown of the added fields according to some embodiment. The UE side associated ID reflects the UE's internal conditions. The stability index indicates the UE's confidence level in probability of how long a functionality may be applicable and/or the accuracy or reliability of the inference results. For example, a confidence level of 8 means the UE is highly confident in the inference it has made (scale: 1-10).

The updated CSI report message not only includes the traditional CSI feedback (channel quality indicator (CQI), precoding matrix indicator (PMI), rank indicator (RI), etc.) but also provides important insights into the UE's inference capabilities, determining stable applicable functionalities and how confident the UE is in those inference and determination of applicable functionality(s). This allows the network to make better decisions about how to allocate resources and manage traffic in real-time, incorporating AI/ML-based optimizations.

The following is an example of an enhanced CSI-MeasConfig message according to some embodiments:

```
CSI-MeasConfig {
  measConfigId: <measConfigId>,
  measurementType: <periodic | aperiodic>,
  reportingType: <type of reporting>,
  reportingInterval: <value>, // applicable for periodic reporting
  measurementObjectList: [
    {
      measurementObjectId: <objectId>,
      UE side associated ID <enable>, // Request to report UE side
      associated ID (could be per
(sub) functionality/use-case/CSI config. basis
      cqiMeasurement: <enable | disable>,
      rsrpMeasurement: <enable | disable>,
      rsrqMeasurement: <enable | disable>,
      mobilityStatus: <enable | disable>
```

The following is an example of an enhanced UAIMessage message according to some embodiments:

```
UAIMessage :: = SEQUENCE {
  UE side Associated ID INTEGER, -- Representing UE side additional
  information
  Stability Index INTEGER, -- for determining functionality
applicability (probability for remaining applicable for a fixed time
duration) and/or inference reliability/accuracy
  context ContextInfo,
  purpose PurposeInfo,
  scope ScopeInfo,
  requirements RequirementsInfo,
  technicalContent TechnicalContentInfo,
  compliance ComplianceInfo,
  conclusion ConclusionInfo,
  annexes SEQUENCE OF AnnexInfo OPTIONAL
}
```

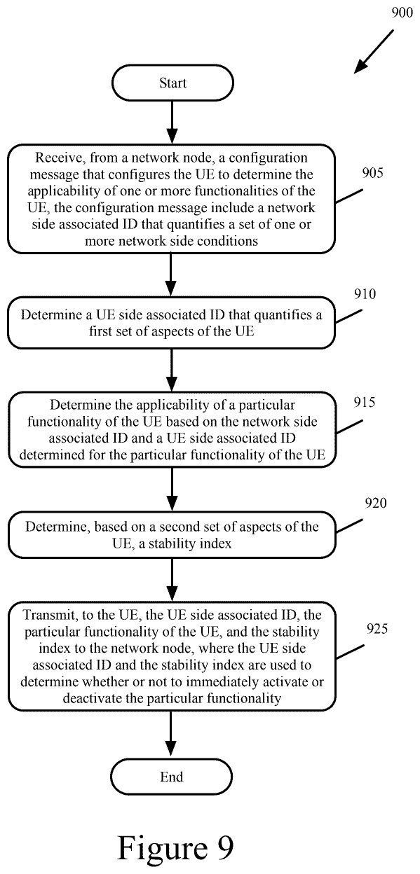

FIG. 9 is a flowchart illustrating an example method/process 900 performed by a UE where the UE determines one or more applicable functionalities and sends the applicable functionalities to the network node, according to an example implementation of the present disclosure. The process 900 may be performed by at least one processor of a UE 101A-101C, shown in FIG. 1.

The process 900 may receive (at block 905) from a network node, a configuration message that configures the UE to determine the applicability of one or more functionalities of the UE, the configuration message include a network side associated ID that quantifies a set of one or more network side conditions. For example, the process 900 may receive a configuration message from the network node 290 as shown in Step 3 of FIG. 6.

The process 900 may determine (at block 910) a UE side associated ID that quantifies a first set of aspects of the UE. For example, the process 900 may determine a UE side associated ID as discussed above with reference to Step 4a of FIG. 6. The first set of the aspects of the UE may include at least a UE hardware resource from several UE hardware resources required for performing the functionality of the UE, the mobility of the UE, or the type of the environment where the UE is located.

The process 900 may determine (at block 915) the applicability of a particular functionality of the UE based on the network side associated ID and a UE side associated ID determined for the particular functionality of the UE. For example, the process 900 may the applicability of a particular functionality of the UE as discussed above with reference to Step 4a of FIG. 6. The particular functionality of the UE, in some embodiments, may be an AI/ML functionality that the UE is ready to apply for AI/ML model inference or an AI/ML functionality that the UE supports based on UE capabilities.

The process 900 may determine (at block 920) based on a second set of aspects of the UE, a stability index. For example, the process 900 may determine the stability index as discussed above with reference to Step 4a of FIG. 6. The second set of aspects of the UE may include at least a UE hardware resource from several UE hardware resources required for performing the functionality of the UE, the mobility of the UE, or the type of the environment where the UE is located. The stability index may specify a probability that the corresponding functionality of the UE remains applicable for a time interval after the functionality of the UE is activated or a probability that the functionality of the UE remains applicable for a time interval prior to the functionality of the UE being activated.

The process 900 may transmit (at block 925) the UE side associated ID, the particular functionality of the UE, and the stability index to the network node. For example, the process 900 may transmit the UE side associated ID, the particular functionality of the UE, and the stability index to the network node as discussed above with reference to Step 4a of FIG. 6. The UE side associated ID and the stability index are used to determine whether or not to immediately activate or deactivate the particular functionality. The UE side associated ID and the stability index, in some embodiments, may be transmitted, to the network node, through L1, L2, or L3 signaling includes a UAI message, a MAC-CE message, a CSI message or report, or an RRC reconfiguration complete message. The process 900 may then end.

The process 900, in some embodiments, may determine, based on the stability index, a duration of time before activating the particular functionality when the particular functionality is not activated, and a duration of time before deactivating the particular functionality when the particular functionality is activated.

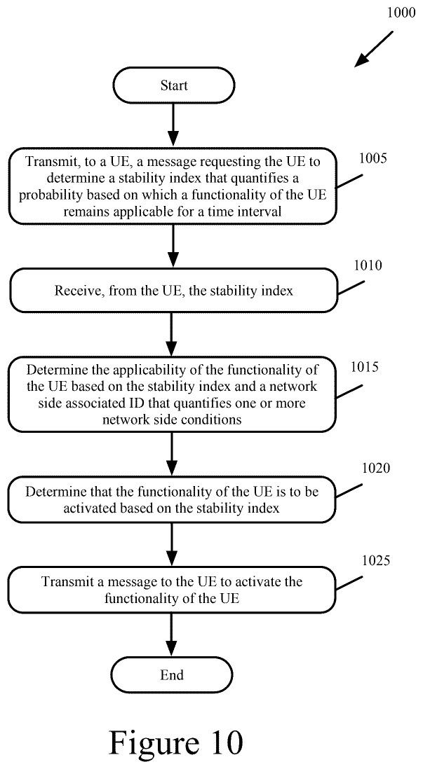

FIG. 10 is a flowchart illustrating an example method/process 1000 performed by a network node where the network node determines one or more applicable functionalities of the UE, according to an example implementation of the present disclosure. The process 1000 may be performed by at least one processor of a BS 103, shown in FIG. 1.

The process 1000 may transmit (at block 1005), to a UE, a message requesting the UE to determine a stability index that quantifies a probability based on which a functionality of the UE remains applicable for a time interval. For example, the process 1000 may transmit a message to the UE 101, as discussed above with references to Step 3 shown in FIG. 7 and Step 3 shown in FIG. 8. The functionality of the UE, in some embodiments, may be an AI/ML functionality that the UE is ready to apply for AI/ML model inference or an AI/ML functionality that the UE supports based on UE capabilities.

The process 1000 may receive (at block 1010), from the UE, the stability index. The stability index may be received, from the UE, through L1, L2, or L3 signaling that may include a UAI message, a MAC-CE message, a CSI message or report, or an RRC reconfiguration complete message. For example, the process 1000 may receive the stability index from the network node 290 as discussed above with reference to Step 4b shown in FIG. 7 or Step 4b shown in FIG. 8.

The process 1000 may determine (at block 1015) the applicability of the functionality of the UE based on the stability index and a network side associated ID that quantifies one or more network side conditions. For example, the process 1000 may determine the applicability of the functionality of the UE as discussed above with reference to Step 5 shown in FIG. 7 or Step 5 shown in FIG. 8.

The process 1000 may determine (at block 1020) that the functionality of the UE is to be activated based on the stability index. For example, the process 1000 may determine that the functionality of the UE is to be activated based on the stability index as discussed above with reference to Step 5 shown in FIG. 7 or Step 5 shown in FIG. 8. The process 100, in some embodiments, may receive, from the UE, a UE side associated ID that is calculated based on a set of aspects of the UE and may determine that the functionality of the UE is to be activated further based on the UE side associated ID. The process 1000 may transmit (at block 1025) a message to the UE to activate the functionality of the UE. The process 1000 may then end.

The process 1000, in some embodiments, may determine that a probability, that the first functionality of the UE remains applicable for the time interval, is below a threshold. The process 1000 may transmit a message to the UE requesting the UE to adjust at least one aspect of the UE. The process 1000 may then receive, from the UE, a revised stability index. In these embodiments, determining that the first functionality of the UE is to be activated may be further based on the revied stability index.

The process 1000, in some embodiments, may receive, from the UE, a message that indicates the UE has rejected activating the first functionality of the UE as a response to the stability index being below the threshold. The process 1000 may transmit, to the UE, a reconfiguration message to enable the UE to activate the first functionality of the UE.

The process 1000, in some embodiments, may receive, from the UE, several functionalities of the UE including the first functionality of the UE. In these embodiments, determining the applicability of the first functionality of the UE may further include selecting the first functionality of the UE from the applicable functionalities.

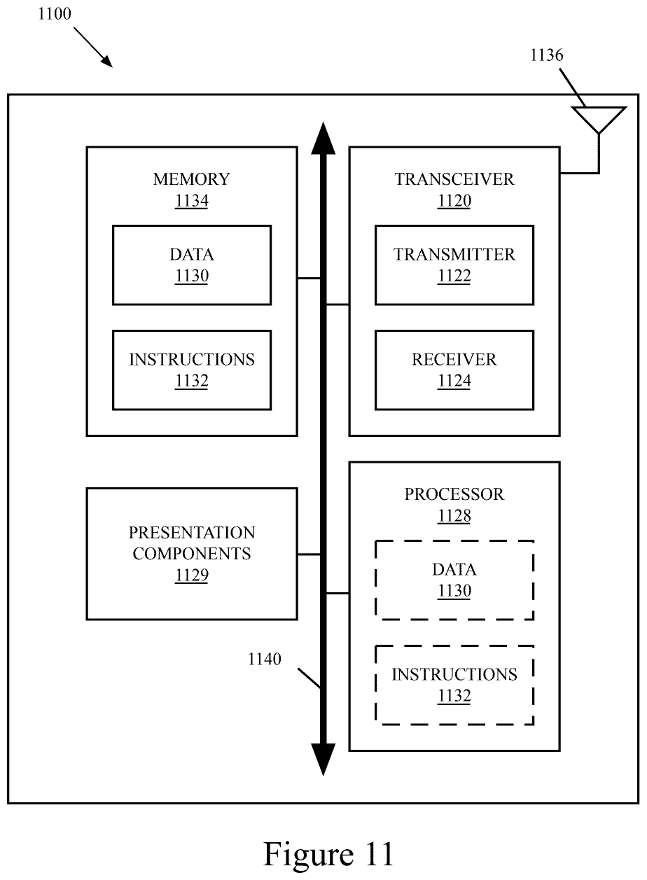

FIG. 11 is a block diagram illustrating a node 1100 for wireless communication, according to an example implementation of the present disclosure. As illustrated in FIG. 11, a node 1100 may include a transceiver 1120, a processor 1128, a memory 1134, one or more presentation components 1129, and at least one antenna 1136. The node 1100 may also include a radio frequency (RF) spectrum band module, a BS communications module, a network communications module, and a system communications management module, Input/Output (I/O) ports, I/O components, and a power supply (not illustrated in FIG. 11).

Each of the components may directly or indirectly communicate with each other over one or more buses 1140. The node 1100 may be a UE, a BS, a LMF server, or any other network node on the RAN side or CN side that performs various functions disclosed with reference to FIGS. 1 through 10.

The transceiver 1120 has a transmitter 1122 (e.g., transmitting/transmission circuitry) and a receiver 1124 (e.g., receiving/reception circuitry) and may be configured to transmit and/or receive time and/or frequency resource partitioning information. The transceiver 1120 may be configured to transmit in different types of subframes and slots including, but not limited to, usable, non-usable, and flexibly usable subframes and slot formats. The transceiver 1120 may be configured to receive data and control channels.

The node 1100 may include a variety of computer-readable media. Computer-readable media may be any available media that may be accessed by the node 1100 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1134 may include computer-storage media in the form of volatile and/or non-volatile memory. The memory 1134 may be removable, non-removable, or a combination thereof. Example memory may include solid-state memory, hard drives, optical-disc drives, etc. As illustrated in FIG. 11, the memory 1134 may store a computer-readable and/or computer-executable instructions 1132 (e.g., software codes) that are configured to, when executed, cause the processor 1128 to perform various functions disclosed herein, for example, with reference to FIGS. 1 through 10. Alternatively, the instructions 1132 may not be directly executable by the processor 1128 but may be configured to cause the node 1100 (e.g., when compiled and executed) to perform various functions disclosed herein.

The processor 1128 (e.g., having processing circuitry) may include an intelligent hardware device, e.g., a Central Processing Unit (CPU), a microcontroller, an ASIC, etc. The processor 1128 may include memory. The processor 1128 may process the data 1130 and the instructions 1132 received from the memory 1134, and information transmitted and received via the transceiver 1120, the baseband communications module, and/or the network communications module. The processor 1128 may also process information to send to the transceiver 1120 for transmission via the antenna 1136 to the network communications module for transmission to a CN.

One or more presentation components 1129 may present data indications to a person or another device. Examples of presentation components 1129 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment may also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from a network node, a network side associated identifier (ID) quantifying one or more network side conditions;
determine a UE side associated ID for each functionality in a set of one or more functionalities of the UE that corresponds to the network side associated ID, the UE side associated ID determined based on a first set of aspects of the UE;
determine a stability index for each functionality of the UE that corresponds to the network side associated ID, the stability index calculated based on a second set of aspects of the UE;
determine an applicability of a particular functionality of the UE based on the network side associated ID and a UE side associated ID determined for the particular functionality; and
determine, based on a stability index determined for the particular functionality and its associated network side associated ID,
a duration of time before activating the particular functionality when the particular functionality is not activated, and
a duration of time before deactivating the particular functionality when the particular functionality is activated.

2. The UE of claim 1, wherein:
the network side associated ID is a first network side associated ID,
the at least one processor is further configured to execute the one or more computer-executable instructions to cause the UE to:
receive, from the network node, a set of one or more network side associated IDs other than the first network side associated ID, each network side associated ID in the set of one or more network side associated IDs quantifying one or more network side conditions,
determining the applicability of the particular functionality of the UE further comprises determining the applicability of the particular functionality of the UE based on the set of one or more network side associated IDs.

3. The UE of claim 1, wherein each stability index specifies a probability that the corresponding functionality of the UE remains applicable for a time interval after the functionality of the UE is activated or a probability that the functionality of the UE remains applicable for a time interval prior to the functionality of the UE being activated.

4. The UE of claim 1, wherein:
each functionality of the UE provides a set of inference results, and
the stability index further quantifies a UE's confidence level in an accuracy or reliability of the set of inference results.

5. The UE of claim 1, wherein each functionality of the UE is one of an artificial intelligence/machine learning (AI/ML) functionality that the UE is ready to apply for AI/ML model inference or an AI/ML functionality that the UE supports based on UE capabilities.

6. The UE of claim 1, wherein the first set of aspects of the UE comprises at least one of a UE hardware resource from a plurality of UE hardware resources required for performing the corresponding functionality of the UE, a mobility of the UE, or a type of an environment where the UE is located.

7. The UE of claim 6, wherein the plurality of UE hardware resources comprises one or more of a UE power consumption, a memory storage of the UE, an operating frequency of a graphics processing unit (GPU) of the UE, and an operating frequency of the at least one processor.

8. The UE of claim 1, wherein the second set of aspects of the UE comprises at least one of a UE hardware resource from a plurality of UE hardware resources required for performing the corresponding functionality of the UE, a mobility of the UE or a type of an environment where the UE is located.

9. The UE of claim 1, wherein determining the UE side associated ID comprises:
determining the UE side associated ID as a function of a score for a battery level of the UE, a score for an availability of computational resources of the UE, a score for environmental conditions and mobility of the UE, and a score on a past effectiveness of the corresponding functionality; and
determining the UE side associated ID by mapping a value generated by the function into one of a plurality of values in a predetermined range of values.

10. The UE of claim 9, wherein the function is one of a non-weighted average or a weighted average.

11. The UE of claim 1, wherein determining the stability index comprises calculating a function of a probability of an occurrence of each aspect in the second set of aspects of the UE.

12. The UE of claim 1, wherein determining the stability index comprises:
calculating a plurality of probabilities for different moving speeds of the UE in different environments;
summing the plurality of probabilities; and
calculating a normalized probability by dividing the sum of the plurality of probabilities by a number of probabilities in the plurality of probabilities.

13. The UE of claim 1, wherein determining the stability index corresponding to a functionality of the UE comprises:
calculating a probability that a battery level of the UE is above a threshold; and
calculating a probability that computational resources required for performing the functionality of the UE is below a threshold.

14. The UE of claim 1, wherein the at least one processor is further configured to execute the one or more computer-executable instructions to cause the UE to:
maintain a mapping of an identification of the UE, the UE side associated ID, the network side associated ID representing the one or more network side conditions, the functionalities of the UE, an applicability status of each functionality of the UE, an activation status of each functionality of the UE, and the stability index.

15. A method, comprising:
receiving, by a user equipment (UE), from a network node, a network side associated identifier (ID) quantifying one or more network side conditions;
determining a UE side associated ID for each functionality in a set of one or more functionalities of the UE that corresponds to the network side associated ID, the UE side associated ID determined based on a set of aspects of the UE;
determining a stability index for each functionality of the UE that corresponds to the network side associated ID, the stability index calculated based on a set of aspects of the UE;
determining an applicability of a particular functionality of the UE based on the network side associated ID and a UE side associated ID determined for the particular functionality; and
determining, based on a stability index determined for the particular functionality and its associated network side associated ID,
a duration of time before activating the particular functionality when the particular functionality is not activated, and
a duration of time before deactivating the particular functionality when the particular functionality is activated.
